(19) United States
(12) Patent Application Publication
(10) Pub. No.: US 2004/0221022 A1
(43) Pub. Date: Nov. 4, 2004

(54) Method and system for configuring a network node

(76) Inventor: Donna Jean Gracyk, Granite Bay, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/425,831

(22) Filed: Apr. 30, 2003

(51) Int. Cl. G06F 15/177; G06F 15/173

(52) U.S. Cl. 709/220; 709/223

(57) ABSTRACT

A method for configuring a node in a computer network includes discovering at least one characteristic of the node, accessing at least one of a policy and a package associated with each at least one discovered characteristic, in response to discovery of the at least one service at the node, and installing the associated at least one of the policy and the package on the node.

### BACKGROUND

There exists a smart plug-in that deploys policies and packages when a service is discovered, but it is hard-coded in a smart plug-in executable which only works for that smart plug-in. It is not a generic solution which can be used by other plug-ins. Hewlett Packard's OpenView VantagePoint for Windows™ (A.06.01) requires a customer to manually deploy policies or packages to a node in a network. The deployed policies or packages configure services available at or through the node.

### SUMMARY

An exemplary method for configuring a node in a computer network includes discovering at least one characteristic of the node, accessing at least one of a policy and a package associated with each at least one discovered characteristic, in response to discovery of the at least one service at the node, and installing the associated at least one of the policy and the package on the node. A machine readable medium can include software or a computer program or programs for causing a computing device to perform the exemplary method.

A exemplary system for configuring a node in a computer network includes a mechanism for discovering at least one characteristic of the node, a mechanism for accessing at least one of a policy and a package associated with each at least one discovered characteristic, in response to discovery of the at least one service at the node, and a mechanism for installing the associated at least one of the policy and the package on the node.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates an exemplary conceptual block diagram.

FIG. 2 illustrates exemplary classes.

FIG. 3 illustrates an exemplary discovered service model.

### DETAILED DESCRIPTION OF THE EXEMPLARY EMBODIMENTS

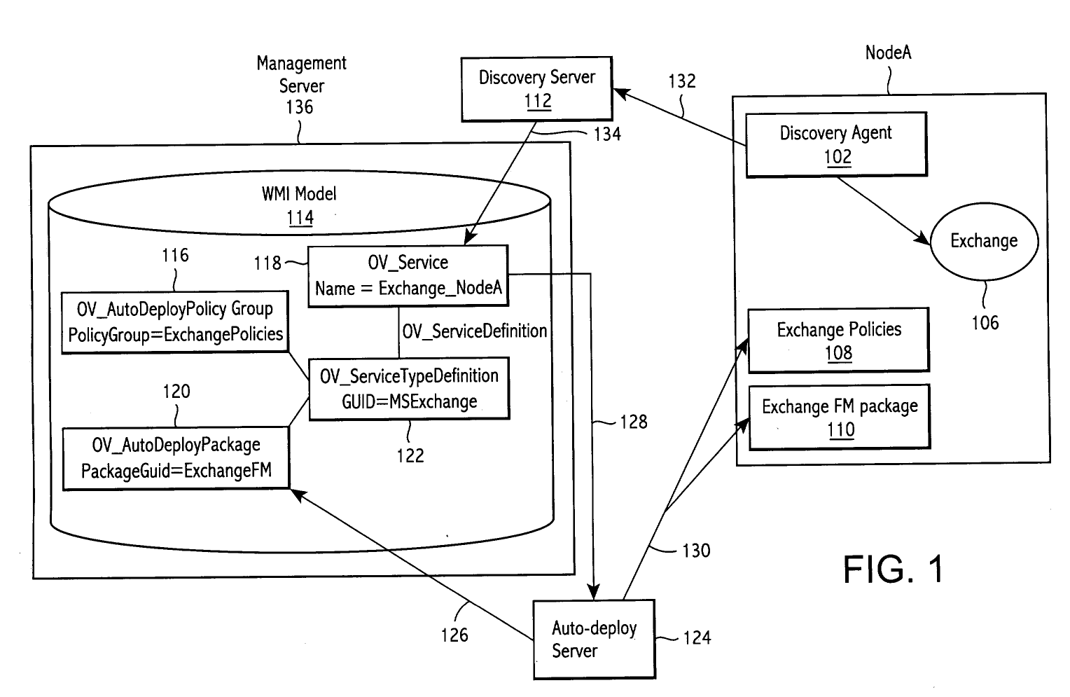

In an exemplary embodiment shown in FIG. 1, a new instance of a characteristic 106 on a node A in a network, is discovered. In response to this discovery, a policy and/or a package associated with the discovered characteristic is accessed, and the corresponding package 110 and/or policy or set of policies 108 is installed or auto-deployed onto the node A. The characteristic can be, for example, a service available at or through the node A, represented for example as a class OV_Service.

For example, an expert team can develop a smart plug-in (SPI), e.g. for Windows™. The SPI can include policies that determine if a computing machine or network node, for example the node A in FIG. 1 which can be for example a Windows™ machine, is healthy (e.g. policies that monitor the performance of the machine, policies that monitor disc space, and so forth). The SPI can also include policies or “rules” on how to discover the services that make up the machine (e.g. memory, central processing unit (CPU), disk drive, etc).

The SPI can be installed on the customer's management server 136 in the network, and the auto-discovery policy can be deployed to the node A. A discovery agent 102 runs the discovery policy, and discovers services included on, or provided by, the node A. For example, the services can include services for each disc drive, and so forth. The discovery agent 102 can run on the node A, or can run on a different machine or server capable of communicating with the node A, for example the discovery server 112, the management server 136, or any other server.

In the example shown in FIG. 1, the discovery agent 102 discovers a service 106 in the node A, for example a service named “Microsoft Exchange”. Each service can have an associated ServiceTypeDefinition (STD). For example, element 122 in FIG. 1 within the network model 114 is an instance “GUID=MS Exchange” of the OV_ServiceTypeDefinition class, that corresponds to Microsoft Exchange. The STD can include metadata describing the service, and describing associations to service component STDs, or in other words STDs of components making up the service.

The discovery agent 102 sends the information on what services have been discovered to the discovery server 112 which then writes the services to the network model 114, for example a Windows™ Management Instrumentation (WMI) model. Thus, the model is updated based on the discovery. The service can be written to the model 114, for example, by establishing an instance “Name=Exchange_NodeA” 118 of an OV_Service class, where this instance of the OV_Service class corresponds to the presence of Microsoft Exchange on node A and is linked in turn to the ServiceTypeDefinition instance 122 of Microsoft Exchange.

In an exemplary embodiment, the ServiceTypeDefinition class is linked to or associated with two new association classes, OV_AutoDeployPackageAssoc and OV_AutoDeplyPolicyGroupAssoc. For example, FIG. 1 shows an instance “Policy Group=Exchange Policies” 116 of the OV_AutoDeployPolicyGroupAssoc class, and also shows an instance “PackageGuid=ExchangeFM” 120 of the OV_AutoDeployPackageAssoc class. These instances indicate groups and policies for MS Exchange. Thus, the association between the discovered characteristic (e.g., the service Microsoft Exchange) and the corresponding policy 116 and package 120 is an instance of an association class (e.g., the instance 122) that links the corresponding policy 116 and the package 120 with an instance of a service class (e.g., the instance 118) defining the service or characteristic.

In response to the updating of the model 114 to reflect discovery of the service 106 on the node A, an event such as an INSTANCE_CREATION_EVENT is generated to reflect the existence of the service. This event is forwarded to the auto-deployment server. The model 114 can generate the event, or an agent or server (for example, the management server 136) can monitor the model 114 to detect the entry of the service into the model and in response generate the event. This event mechanism can be configured through an external MOF (Managed Object File) file, that can be for example compiled on the management server 136. The model 114 can be hosted or implemented in the management server 136 of the network, or can be hosted on any other appropriate server or machine in the network. The model can also be implemented using any object-oriented database capable of supporting the event mechanism. The event mechanism can contain an event filter, which can be implemented as shown below:

```
Instance of_EventFilter
{
  Name = “OVAutoDeploy Service Creation filter”;
  Query = “select * from_InstanceCreationEvent where
TargetInstance._Class=\“OV_Service\””;
  QueryLanguage = “WQL”;
}
```

In an exemplary embodiment, the event filter is written or configured so that any object that has an associated TypeDefinition (not just a service) can be sent to the deployment server. In this situation, all the deployment server needs is the policy and package names associated with or linked to the TypeDefinition of the object, and the machine name of where to deploy the package and/or policy or policies. The TypeDefinition of the object can be a high level abstract class.

Reception of the event by the auto-deployment server 124 via a link 128 triggers the auto-deployment server 124, so that it auto-deploys the appropriate package and/or policy or policies to the node A, for example the policy/policies 108 and the package 110. Thus, based on the updating, the auto-deployment server 124 is triggered to perform the accessing of the package and/or policies, for example the elements 116, 120 in FIG. 1, and to perform the installing of the accessed package and/or policy or policies onto the node A. These actions can be accomplished, for example, by executing the following pseudocode:

```
AutoDeployConsumer::IndicateToConsumer( objects)
{
  // Objects are 1 or more instances of OV_SERVICE as specified in the
  // event filter
  For each object in objects
  {
    Get service name out of object -> serviceName
    Get machine name that this service is hosted on -> machineName
    Get ServiceTypeDefinition for this service -> STD
    Get enumeration of deployment packages associated with
    STD -> packages
    For each package in packages
    {
      Deploy package to machineName
    }
    Get enumeration of policies associated with STD -> policies
    For each policy in policies
    {
      Deploy policy to machineName
    }
  }
}
```

The auto-deploy server 124 can access the instances 116, 120 in the model 114 via a link 126, to obtain and/or discern the packages and/or policies associated with the Microsoft Exchange STD. After obtaining and/or discerning the packages and/or policies associated with the Microsoft Exchange STD, the auto-deploy server 124 deploys them to the node A via a link 130 to establish the Microsoft Exchange Policies 108 and the Microsoft Exchange FM Package 110 at the node A.

Additional details regarding classes useful in an exemplary embodiment will now be provided.

“OV_Service” is a class that is the instantiated service instance that gets discovered, for example by the discovery agent 102. A service can represent an application or system object such as a database, a disc drive, and so forth. Each service instance has a corresponding OVServiceTypeDefinition.

“OV_ServiceTypeDefinition” is a class that can function as a “blueprint” defining the service instances. The OV_ServiceTypeDefinition class contains information and pointers to other classes on how to build a service. The OV_ServiceTypeDefinition can also contain relationships to other ServiceTypeDefinitions which indicate the parent/child relationships that can be built (for example a Disc service will be a child of a Storage service). There can be many OV_Service instances associated with one OV_ServiceTypeDefinition. For example, a ServiceTypeDefinition for a Disc class can have many associated service instances for Disc_a:, Disc_c:, and so forth.

In an exemplary embodiment, the following classes can be added and used specifically for auto-deployment.

“OV _AutoDeployPackage” is a class containing the name of the package to auto-deploy.

“OV_AutoDeployPackageAssoc” is a class that is an association class that associates the package in OV_AutoDeployPackage with a ServiceTypeDefinition.

“OV_AutoDeployPolicyGroup” is class that contains the name of the policy group to auto-deploy. A policy group is a collection of policies.

“OV_AutoDeployPolicyGroupAssoc” is a class that is an association class that associates the policy group in OV_AutoDeployPolicyGroup with a ServiceTypeDefinition.

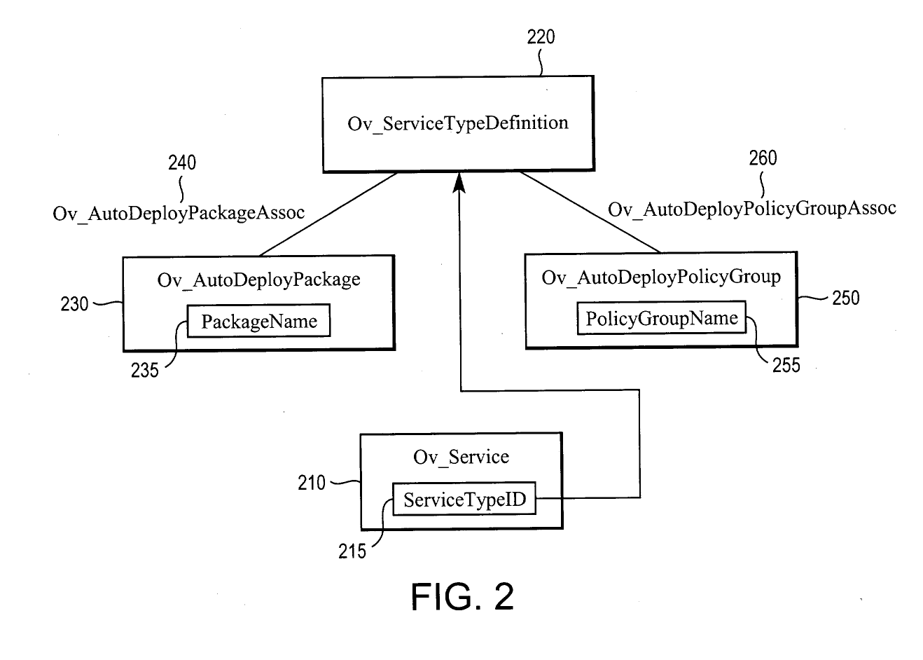

These classes are shown for example in FIG. 2. As shown in FIG. 2, OV_Service 210 has a field ServiceTypeID 215 and points to OV_ServiceTypeDefinition 220. OV_AutoDeployPackage 230 has a field PackageName 235 and points to or is linked to OV_ServiceTypeDefinition 220 via OV_AutoDeployPackageAssoc 240. OV_AutoDeployPolicyGroup 250 has field PolicyGroupName 255 and points to or is linked to OV_ServiceTypeDefinition 220 via OV_AutoDeployPolicyGroupAssoc 260.

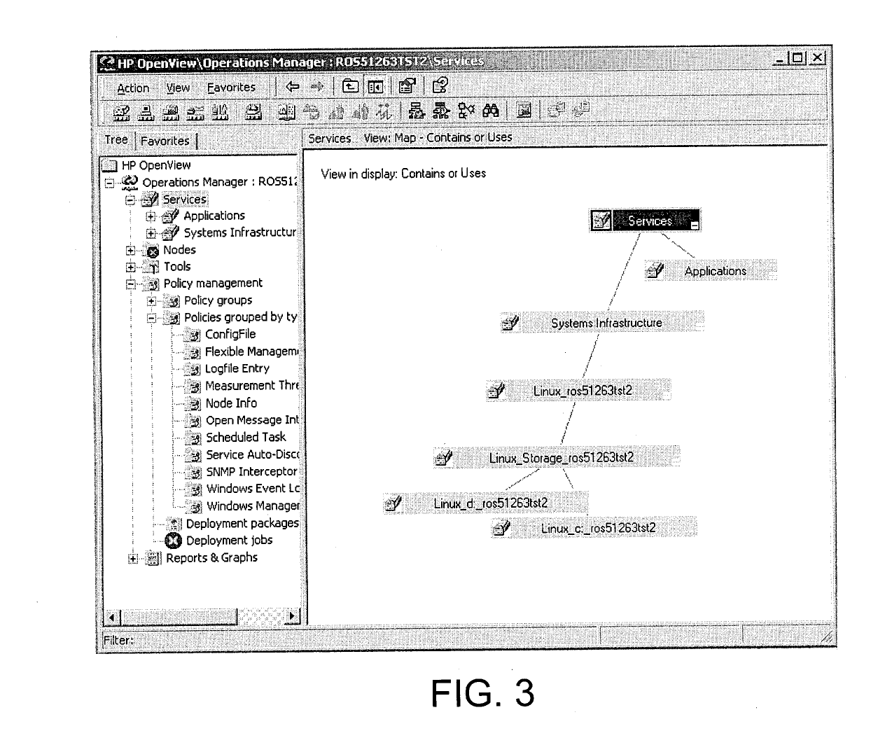

FIG. 3 illustrates an exemplary discovered service model, wherein discovered services include Applications, and also include disk drives Linux_d:_ros51263tst2 and Linux_c:_ros51263tst2. The disk drives are linked to the heading Services by the intermediate headings Linux_Storage_ros51263tst2, Linux_ros51263tst2, and Systems Infrastructure.

Any number of packages or policies can be associated with a service, for example by creating a new instance of OV_AutoDeployPolicyGroup or OV_AutoDeployPackage and associating the new instance with the appropriate STD. A WMI permanent event consumer can also be created, and then invoked for any instance operation event on the OV_Service class. The WMI permanent event consumer can navigate the model 114 to see if there are any associated policies or packages, and then auto-deploy the associated policies or packages to the node where the corresponding service is discovered.

In accordance with an exemplary embodiment, solutions described herein can be generically applied by any smart plug-in or by any customer who wants to configure what policy groups or packages will be automatically deployed when a service is discovered at a node of a network. In accordance with an exemplary embodiment, the mechanisms described herein can be used to automatically deploy policy groups and/or packages when an instance of any class in a model is populated. Thus policy groups and/or packages can be automatically deployed not only for classes related to services provided at or through a node in a network, but also for other classes, for example classes that relate to any capability or characteristic of the node.

The model can be, for example, Windows Management Instrumentation, or any other network model. Thus, a plug-in or a customer can add new packages and/or policies to the model on the fly, without having to write or compile code.

The methods, logics, techniques and pseudocode sequences described above can be implemented in a variety of programming styles (for example Structured Programming, Object-Oriented Programming, and so forth) and in a variety of different programming languages (for example Java, C, C ++, C#, Pascal, Ada, and so forth).

Those skilled in the art will appreciate that the elements and methods or processes described herein can be implemented using a microprocessor, computer, or any other computing device, and can be implemented in hardware and/or software, in a single physical location or in distributed fashion among various locations or host computing platforms. Agents can be implemented in hardware and/or software or computer program(s) at any desired or appropriate location. Those skilled in the art will also appreciate that software or computer program(s) can be stored on a machine-readable medium, wherein the software or computer program(s) includes instructions for causing a computing device such as a computer, computer system, microprocessor, or other computing device, to perform the methods or processes.

It will also be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein.

1. A method for configuring a node in a computer network, comprising:
discovering at least one characteristic of the node;
accessing at least one of a policy and a package associated with each at least one discovered characteristic, in response to discovery of the at least one service at the node; and
installing the associated at least one of the policy and the package on the node.

2. The method of claim 1, wherein the association between the at least one characteristic and the at least one of the policy and the package is an instance of an association class that links the at least one of the policy and the package with an instance of a service class defining the characteristic.

3. The method of claim 1, wherein the at least one characteristic is a service provided at or through the node.

4. The method of claim 1, comprising:
an agent running a discovery policy to discover the at least one characteristic of the node.

5. The method of claim 4, comprising:
updating a network model based on the discovered at least one characteristic;
based on the updating, triggering a server to access at least one policy and/or at least one package associated with the at least one characteristic; and
deploying the accessed at least one policy and/or at least one package at the node.

6. A system for configuring a node in a computer network, comprising:
means for discovering at least one characteristic of the node;
means for accessing at least one of a policy and a package associated with each at least one discovered characteristic, in response to discovery of the at least one service at the node; and
means for installing the associated at least one of the policy and the package on the node.

7. The system of claim 6, wherein the association between the at least one characteristic and the at least one of the policy and the package is an instance of an association class that links the at least one of the policy and the package with an instance of a service class defining the characteristic.

8. The system of claim 6, wherein the at least one characteristic is a service provided at or through the node.

9. The system of claim 6, comprising:
an agent arranged to run a discovery policy to discover the at least one characteristic of the node.

10. The system of claim 9, comprising:
means for updating a network model based on the discovered at least one characteristic;
means for triggering a server to access at least one policy and/or at least one package associated with the at least one characteristic, based on the updating; and
means for deploying the accessed at least one policy and/or at least one package at the node.

11. A machine readable medium comprising a computer program for causing a computer to perform:
discovering at least one characteristic of the node;
accessing at least one of a policy and a package associated with each at least one discovered characteristic, in response to discovery of the at least one service at the node; and
installing the associated at least one of the policy and the package on the node.

12. The medium of claim 11, wherein the association between the at least one characteristic and the at least one of the policy and the package is an instance of an association class that links the at least one of the policy and the package with an instance of a service class defining the characteristic.

13. The medium of claim 11, wherein the at least one characteristic is a service provided at or through the node.

14. The medium of Claim I1, wherein the computer program causes the computer to perform:
running a discovery policy to discover the at least one characteristic of the node.

15. The medium of claim 14, wherein the computer program causes the computer to perform:
updating a network model based on the discovered at least one characteristic;
based on the updating, triggering a server to access at least one policy and/or at least one package associated with the at least one characteristic; and
deploying the accessed at least one policy and/or at least one package at the node.
